(19) United States
(12) Patent Application Publication
(10) Pub. No.: US 2014/0129751 A1
(43) Pub. Date: May 8, 2014

(54) HYBRID INTERFACE TO IMPROVE SEMICONDUCTOR MEMORY BASED SSD PERFORMANCE

(71) Applicant: TAEJIN INFO TECH CO., LTD., Seoul (KR)

(72) Inventor: Byungcheol CHO, Seoul (KR)

(73) Assignee: TAEJIN INFO TECH CO., LTD., Seoul (KR)

(21) Appl. No.: 13/671,078

(22) Filed: Nov. 7, 2012

(51) Int. Cl. G06F 13/24

(52) U.S. Cl. 710/260

(57) ABSTRACT

A system and hybrid interface for high-performance memory-based storage devices are disclosed. The hybrid interface includes a polling interface and interrupt interface that are selected by a consideration of latency and CPU usage for a particular request to the storage device.

### BACKGROUND

Semiconductor memory based semiconductor storage devices (SSDs) are capable of a short response time as compared to hard disk drives (HDDs). The host interfaces used for SSDs, particularly PCI-Express interfaces, provide high bandwidth capabilities. Host interfaces generally function to provide data bus lines into a computer system for communicating with components of the computer system including one or more central processing units (CPUs). In order for a device to safely transfer data across one or more of the data bus lines into the computer system, the data bus lines should not be in use by another component of the system.

Typically, a host interface uses an interrupt to send a signal to the computer system and indicate that data will be transferred across a data bus line by the device. Interrupts are also used to signal to the host interface that another device is transferring data across the data bus line. Interrupts enable higher efficiency processing by a CPU because the CPU is assigned to and performs other tasks until an interrupt is received. However, a large overhead is required to handle interrupts because the CPU handles an incoming interrupt after switching a current task, increasing latency. Therefore, interrupt-based interfaces such as conventional SATA or SAS storage interface and even a PCI-based high performance SSD interface (which is expected to exhibit some performance degradation when interrupt is used), can make it difficult to meet the needs of next-generation ultra-latency memory applications.

### BRIEF SUMMARY

A hybrid interface for semiconductor memory based storage devices and techniques for managing the hybrid interface are disclosed herein.

In accordance with embodiments of the invention, a hybrid interface and interface management technique for storage devices are provided that supports both polling and interrupts.

According to one aspect, a hybrid interface for a semiconductor memory based storage device (SSD) having ultra-latency characteristics is provided. The hybrid interface supports both polling and interrupt and provides control to enable a polling interface and an interrupt interface depending on one or more characteristics of an I/O request. In one embodiment, the SSD includes a storage device controller and register set having an interrupt disable register and a status register.

According to another aspect, a software to control the hybrid interface in consideration of latency and CPU utilization is provided. The software supports techniques for selecting polling or interrupt-based interfaces of the hybrid interface in consideration of latency and CPU utilization of semiconductor memory. In one embodiment, a software driver is provided that causes an interrupt disable register of an SSD to be written to in order to enable and disable the interrupt-based interface in order to switch to a polling-based interface according to a calculated decision based on latency and CPU utilization for a particular I/O request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an interrupt-based storage interface.

FIG. 2 shows a hybrid storage interface in accordance with an embodiment of the invention.

FIG. 3 shows a method of using a hybrid storage interface for a high-performance memory-based SSD in accordance with an embodiment of the invention.

FIG. 4 shows a graph illustrating the decision factors in selecting an interface of the hybrid storage interface in accordance with an embodiment of the invention.

### DETAILED DISCLOSURE

A hybrid interface for semiconductor memory based SSD having short latency and techniques for managing the hybrid interface are provided.

In accordance with embodiments of the invention, a hybrid interface and interface management technique for storage devices is provided that supports both polling and interrupts.

According to one embodiment, a storage device and hardware interface is provided that supports selection between interrupt and polling based on a characteristic of an I/O request.

According to another embodiment, a technique is provided that mixes polling and interrupt-based methodologies according to latency and CPU utilization characteristics of a semiconductor memory in order to manage the hardware interface.

In various embodiments, a semiconductor memory based high performance storage device and driver (and software) therefore are provided. In certain embodiments, the high performance storage device and driver utilize high bandwidth channel interfaces including, but not limited to, PCI-express.

Certain embodiments of the invention can provide an ultra-latency interface for semiconductor storage devices. Currently, ultra latency (or ultra-low latency) refers to latency of less than 1 millisecond; and it is expected that latencies will be reduced to the hundreds and tens of microseconds (limited by the speed of light). In accordance with an embodiment of the invention, a hybrid interface is provided that utilizes both interrupt and polling and can determine an optimal interface considering latency and CPU usage.

Polling refers to a direct/active operation by a computer processor to determine the status of a device (e.g., whether the device is ready to be accessed). Often, a device is assigned a special address in memory (i.e. memory-mapped). A device's host interface provides the necessary logic required to interpret the device address generated by the processor and enables communication between the device, such as an I/O device (e.g., a storage device), and the processor. Thus when polling, a processor can check the status of the device by reading data from an assigned address for the device. In many cases, the device being checked operates at a slower speed than the processor. In those cases, polling can be inefficient because the processor is busy waiting for the device instead of performing other tasks. An advantage of polling is that the processor determines how often and when to poll. In contrast, an interrupt causes the processor to stop executing a task.

An interrupt is a process or signal that indicates to a processor that a current process running on a processor or controller should be stopped (or paused) in order to enable another (higher priority) process to be performed or occur. An interrupt can be software or hardware based. A PIC is a programmable interrupt controller. The PIC receives requests for an interrupt from hardware devices, including storage devices and sends an interrupt signal to the computer processor (e.g., the central processing unit—CPU). The PIC may be a separate chip or embedded with the CPU. An interrupt input line of the PIC can be referred to as an interrupt request (IRQ) line.

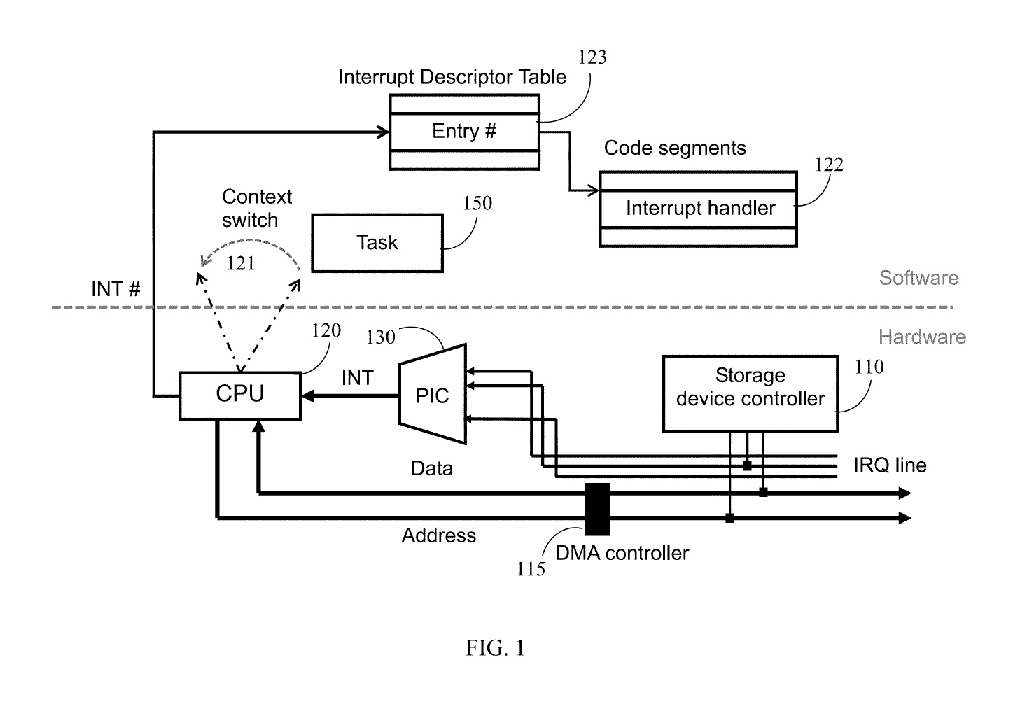

FIG. 1 shows an interrupt-based storage interface. Referring to FIG. 1, the hardware portion of an interface between a storage device (including storage device controller 110 and DMA controller 115) and a CPU 120 includes a system bus with signal bus lines for Data, Address, and IRQ. A PIC 130 can be provided to control the order and timing of an interrupt (INT) sent to the CPU 120.

The software portion can be part of an operating system kernel. When an interrupt is generated (and the interrupt request received by the CPU 120), the current execution state of a task is saved via a context switch 121 and the CPU 120 can begin execution of an interrupt handler 122 at the interrupt vector (entry#) indicated by, for example, an interrupt descriptor table (IDT) 123. The IDT is a data structure implementing an interrupt vector table, which is used by a processor to determine the correct response to an interrupt.

In operation, when a CPU requests data from a storage device, the CPU 120 can issue the read request and continue with some other execution. When the read is completed by the storage device, the CPU 120 can be interrupted (i.e., receive an interrupt request) in order to be presented with the read (i.e., the requested data).

For example, when an I/O request (e.g., a request, such as a read request, to a storage device) issued by an operating system is completed, the storage device controller 110 issues an interrupt request via an IRQ line 140 to a PIC 130. When the CPU 120 receives the interrupt INT, the CPU 120 saves its task 150 using a context switch 121 and performs a search for an interrupt service routine (interrupt handler 122) code segment for a corresponding interrupt at the IDT 123 to process the interrupt (matching INT# to Entry#). The interrupt service routine is an executable code triggered by the reception of an interrupt.

Interrupt latency refers to the time that elapses from when an interrupt is generated to when the source of the interrupt is serviced. For many operating systems, devices are serviced when the device's interrupt handler (e.g., interrupt handler 122) is executed by the processor. Each interrupt temporarily stops the execution of a current program/task 150 in order to execute some higher priority I/O subroutine before returning to the original program/task 150. Context switching (context switch 121) refers to the act of switching from one task to another. Context switching adds overhead to the computing process. For example, to ensure that the original program/task does not lose any of its progress, the current state of the CPU is saved to memory before switching to the new higher priority I/O subroutine. When switching back to the original program, the state of the CPU must first be loaded from memory. These actions take time and, for ultra-latency applications, interrupts can introduce an unacceptable amount of latency.

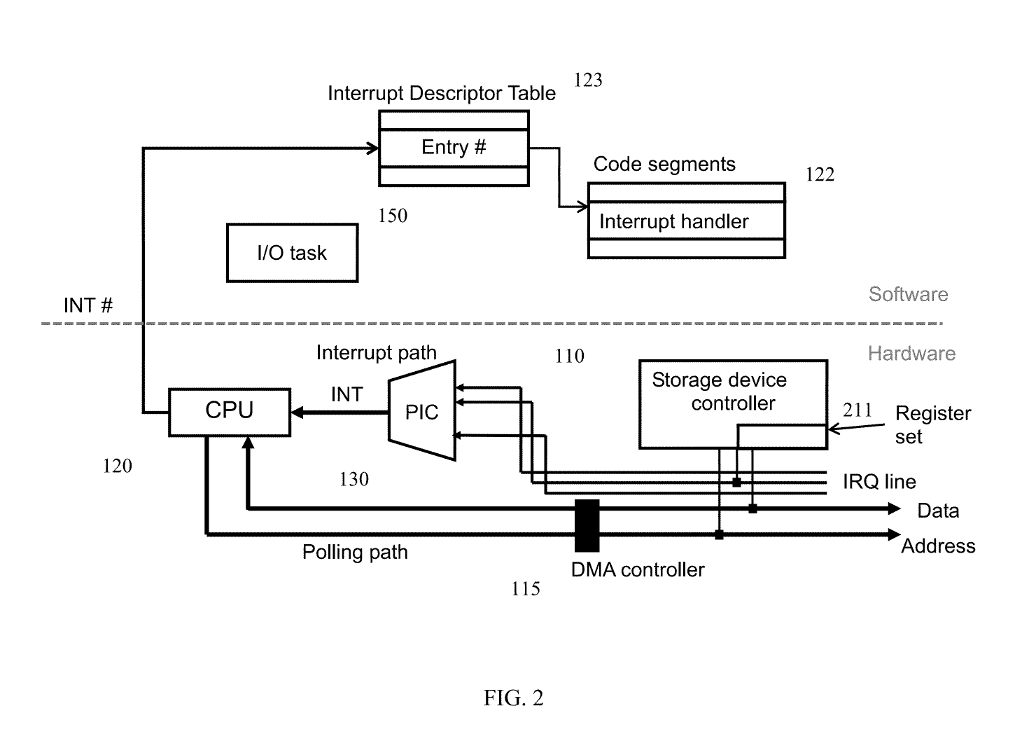

FIG. 2 shows a hybrid interface according to an embodiment of this invention. The hardware structure is configured to enable interrupts and provide disabling of the interrupts sent from the connected storage device. Therefore, a similar configuration as shown by the interrupt-only interface of FIG. 1 can be used for the hybrid interface. As the interrupt configuration is described in detail with respect to FIG. 1, a specific description of the details of the interrupt configuration will be omitted.

Referring to FIG. 2, according to one embodiment of a hybrid interface, the storage device controller 210 includes a control register 211. The control register 211 is a local memory or cache quickly accessible and manipulatable by a processor and/or logic of the storage device controller 210. In accordance with various embodiments of the invention, the control register 211 includes a register directed to enabling/disabling interrupt and a status register.

In accordance with certain embodiments of the invention, an operating system can determine which style of interface to use (polling or interrupt) for each request from the CPU 220 to the storage device and control the interface through a control register 211 of the storage device controller 210. To implement polling, the interrupt of the storage device is disabled via the register disabling interrupt of the control register 211 and completion of a request is confirmed by periodically reading the status register of the control register 211 of the storage device assigned to a particular address.

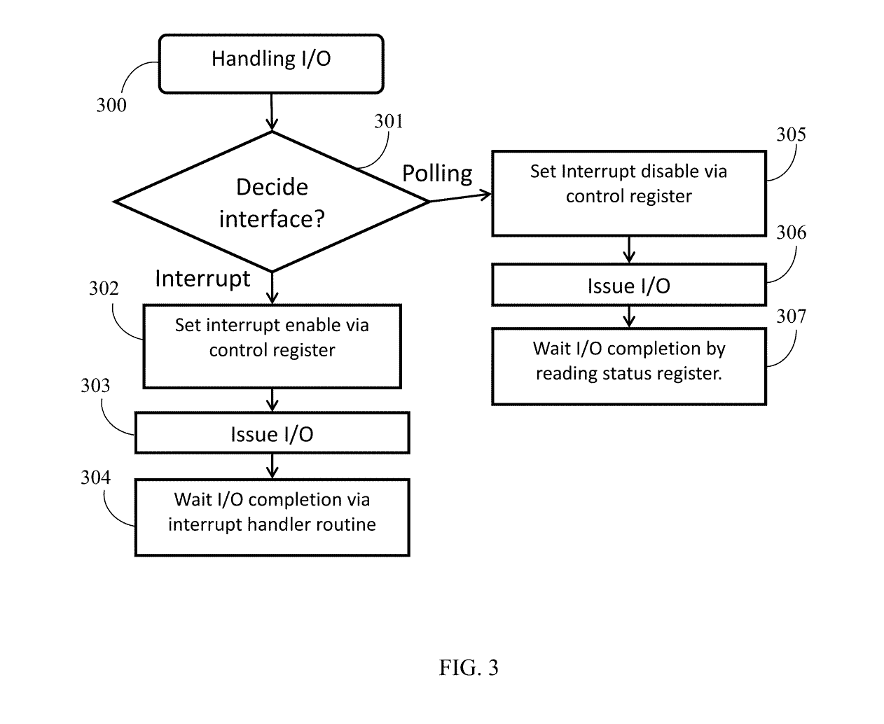

FIG. 3 shows a flow chart of a software program that when executed by a processor enables a selection and use of a determined interface of a hybrid interface according to an embodiment of the invention. The software determines which interface is better to use and waits for a completion of a request depending on a determined interface. The software program can be in the form of a device driver. A device driver is a kernel module that is coded to communicate with a particular device. The device driver can support a standard set of operations, which may be implemented differently according to device.

For handling I/O, an I/O subroutine (kernel module of device driver) 300 may be called to control the interface between the kernel of the operating system and a storage device. In step 301, a decision is made to determine which of the polling or interrupt interface is appropriate for a service request by the operating system. If it is determined that an interrupt is appropriate, then the operating system sends a command in step 302 to set interrupt enable via the control register (211) of the storage device controller (210). Then, the operating system can direct a request to the storage device and by issuing I/O request 303. In step 304, while waiting for I/O completion, the CPU can be assigned other tasks by the operating system and will then yield to the interrupt according to the interrupt handler routine (122). If it is determined during step 301 that polling is appropriate, the operating system sends a command in step 305 to set interrupt disable via the control register (211) of the storage device controller (210). Then, the operating system can direct a request to the storage device and by issuing I/O request 306. In step 307, the CPU stays busy during the wait for I/O completion by reading the status register for the storage device.

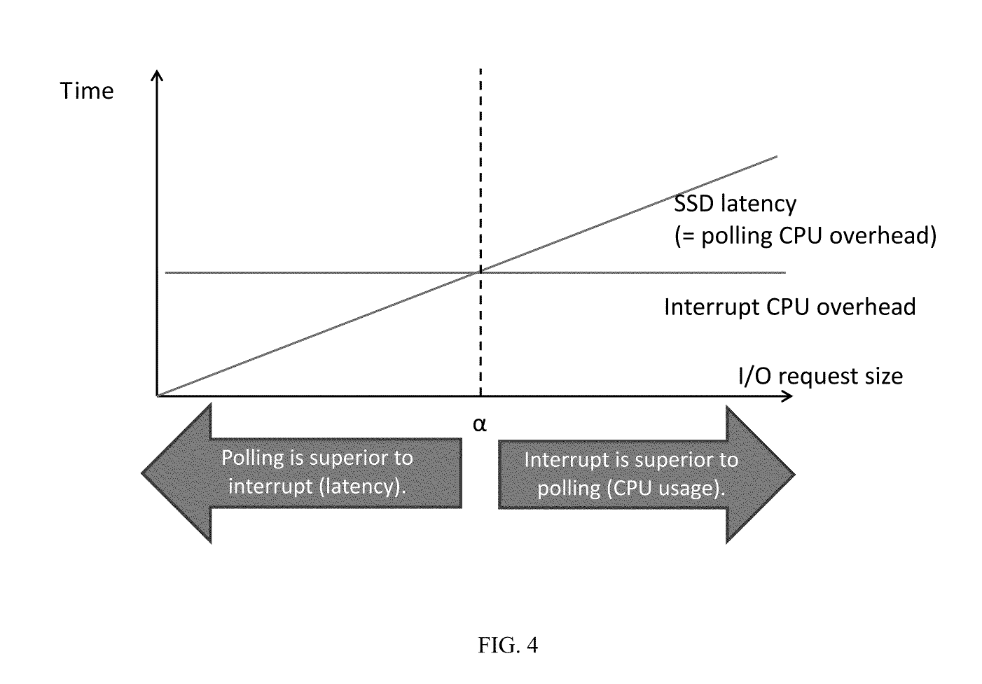

FIG. 4 shows a graph indicating standards to determine an interface in accordance with an embodiment of the invention. The standards to determine an interface include latency and CPU usage based on size and/or type of a request. That is, polling is used when CPU overhead to process an interrupt is larger than latency of a device, or an interrupt is used considering utilization rate of CPU. At a particular I/O request size threshold α an Interrupt can be superior to polling due to CPU usage (the amount of latency/time required to perform the polling due to I/O request size). Below that threshold α, polling is superior to interrupt in terms of latency. Accordingly, in one embodiment, in step 301 the I/O request size can be checked against the threshold α (in which the latency of waiting for the I/O request to be completed is larger than acceptable for a particular application) in order to determine whether polling or interrupt will be selected.

In accordance with various aspects of the invention, the hybrid interface and management software can be implemented on a computer system having hardware including one or more central processing units (CPUs), memory, mass storage (e.g., HDD, SSD), and I/O devices (e.g., network interface, user input devices). Elements of the computer system hardware can communicate with each other via a bus.

The computer system hardware can be configured according to any suitable computer architectures such as a Symmetric Multi-Processing (SMP) architecture or a Non-Uniform Memory Access (NUMA) architecture. The one or more CPUs may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Certain techniques set forth herein may be described in the general context of software or computer-executable instructions, such as program modules, executed by one or more computers or other devices. Certain embodiments of the invention contemplate the use of a computer system or virtual machine within which a set of instructions, when executed, can cause the system to perform any one or more of the methodologies discussed above. Generally, program modules include routines, programs, objects, components, and data structures that perform particular tasks or implement particular abstract data types.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data. Computer-readable media should not be construed or interpreted to include any propagating signals.

Of course, the embodiments of the invention can be implemented in a variety of architectural platforms, devices, operating and server systems, and/or applications. Any particular architectural layout or implementation presented herein is provided for purposes of illustration and comprehension only and is not intended to limit aspects of the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. An interface for high-performance memory-based storage devices, comprising:
a polling interface to a storage device; and
an interrupt interface to the storage device, the selection of the polling interface and the interrupt interface performed by a central processing unit (CPU) of a host by a consideration of latency and CPU usage for a particular request to the storage device.

2. The interface according to claim 1, wherein the polling interface is selected by disabling an interrupt register of the storage device and completion of the particular request is confirmed by periodically reading a status register of the storage device.

3. The interface according to claim 1, wherein the interrupt interface is selected by enabling an interrupt register of the storage device and completion of the particular request is indicated by an interrupt request sent by the storage device.

4. The interface according to claim 1, wherein the selection of the polling interface is performed when a size of the particular request would cause CPU overhead to process an interrupt to be larger than latency of the storage device in processing the particular request.

5. The interface according to claim 1, wherein the selection of the interrupt interface is performed when a size of the particular request would cause latency of the storage device in processing the particular request to be larger than CPU overhead to process an interrupt.

6. A computer-readable medium having instructions stored thereon that, when executed by a processor, cause the processor to perform a method comprising:
determining which of a polling interface or an interrupt interface of a hybrid interface of a storage device is appropriate for a service request;
if the polling interface is determined, setting a register of the storage device to disable interrupts;
if the interrupt interface is determined, setting the register of the storage device to enable interrupts; and
issuing the service request to the storage device after determining which of the polling interface or the interrupt interface is appropriate.

7. The computer readable medium according to claim 6, wherein the determining which of the polling interface or the interrupt interface is appropriate comprises:
selecting the polling interface when a size of the service request would cause CPU overhead to process an interrupt to be larger than latency of the storage device in processing the service request; and
selecting the interrupt interface when the size of the service request would cause latency of the storage device in processing the service request to be larger than CPU overhead to process the interrupt.

8. The computer readable medium according to claim 6, wherein the determining which of the polling interface or the interrupt interface is appropriate comprises:
determining a size of a particular request to the storage device; and
comparing the size to a threshold value indicative of whether a latency of waiting for an I/O request to be completed by the storage device is larger than acceptable for a particular application, wherein a result indicative of a value below the threshold provides a determination of the polling interface and a result indicative of a value above the threshold provides a determination of the interrupt interface.

9. A computer system comprising:
a central processing unit (CPU);
a storage device operably connected to the CPU; and
a hybrid interface driver associated with the storage device such that when executed by the CPU controls a selection of a polling interface and an interrupt interface of the hybrid interface.

10. The computer system according to claim 9, wherein the storage device comprises a register for enabling/disabling interrupts, the hybrid interface driver enabling a selection of the register upon a determination of the polling interface and the interrupt interface.

11. The computer system according to claim 10, wherein the selection of the polling interface is determined when a size of a particular request would cause CPU overhead to process an interrupt to be larger than latency of the storage device in processing the particular request.

12. The computer system according to claim 10, wherein the selection of the interrupt interface is determined when a size of a particular request would cause latency of the storage device in processing the particular request to be larger than CPU overhead to process an interrupt.
